(19) United States
(12) Patent Application Publication
(10) Pub. No.: US 2021/0359355 A1
(43) Pub. Date: Nov. 18, 2021

(54) BATTERY MODULE WITH TEMPERATURE CONTROL

(71) Applicant: Robert Bosch GmbH, Stuttgart (DE)

(72) Inventors: Markus Schmitt, Tamm (DE); Benjamin Kopp, Remseck Am Neckar (DE); Christian Loew, Stuttgart (DE); Roman Marx, Moensheim (DE)

(21) Appl. No.: 17/321,931

(22) Filed: May 17, 2021

(30) Foreign Application Priority Data
May 18, 2020 (DE) 10 2020 206 191.2

(51) Int. Cl. H01M 10/653; H01M 50/204; H01M 10/613; H01M 10/625; H01M 10/6556; H01M 10/0525

(52) U.S. Cl. CPC H01M 10/653; H01M 50/204; H01M 10/613; H01M 2220/20; H01M 10/6556; H01M 10/0525; H01M 10/625

(57) ABSTRACT

A battery module includes a plurality of battery cells (14), in particular rechargeable lithium ion battery cells or lithium polymer battery cells, the plurality of battery cells (14) being arranged in the form of a stack (12) of battery cells and the stack (12) of battery cells being enclosed at its outer face by a mechanical bracing device (20), a layer of thermally conductive material (22) being located between the outer face of the stack (12) of battery cells and the mechanical bracing device (20).

### BACKGROUND OF THE INVENTION

The present invention relates to a battery module, to a method for the production thereof and to use thereof.

Conventional batteries in the field of electromobility comprise a plurality of battery cells, which are for example grouped into a cell stack and interconnected electrically. Such cell stacks are ultimately inserted into a corresponding battery housing. Due to electrochemical conversion processes within the battery cells, in particular lithium ion and lithium polymer battery cells in battery systems heat up significantly, primarily during rapid energy output or uptake. The greater the power of a battery pack formed of the battery cells, the greater is the corresponding release of heat and the greater the need for an efficient active thermal management system.

In addition to efficient cooling of the battery cells, it is however also increasingly important to be able to heat up battery cells in particular at low temperatures of below 10° C., wherein such cells can only be charged to a limited degree at such temperatures, since otherwise there is a risk of “lithium plating”. To ensure full energy uptake by the battery cells, active heating of the battery cells is needed to bring the battery cells to a sufficiently high temperature level.

Temperature control of battery cells conventionally takes place these days by liquid temperature control using conventional water/glycol mixtures. In this case, a corresponding fluid is passed through ducts in a cooling element arranged for example under the stack of battery cells. This cooling element is a component of a corresponding cooling circuit.

Conventionally, heat is thus dissipated from battery cells of a battery module via the bottom faces of the respective battery cells. To this end, the respective bottom faces of the battery cells are for example in direct physical contact with a cooling plate through which a cooling medium flows, such that a corresponding thermal flux may proceed from the battery cell through the corresponding bottom face of the battery cell housing and the cooling plate into the corresponding cooling medium. For improved thermal contacting of the bottom face of the battery cell housing, it is additionally possible, for example, to provide a thermal interface material (TIM), which ensures an improved thermally conductive connection of the bottom face of the battery cell housing to the surface of a corresponding cooling element.

In this respect, a battery module is known from US 2018/0053970 in which a plurality of battery cells forms a battery cell stack, wherein thermally conductive plates are arranged in each case between the battery cells. Furthermore, a battery module with a battery cell stack is known from DE 10 2015 010 925, wherein the battery cell stack is heated or cooled with the assistance of a temperature control unit located in the top region of the battery cells.

### SUMMARY

The invention provides a battery module, a method for the production thereof and use thereof, with the characterizing features of the independent patent claims.

The battery module according to the invention comprises a plurality of battery cells, wherein these are arranged in the form of a stack of battery cells. The battery cells are for example rechargeable lithium ion battery cells or lithium polymer battery cells. The stack of battery cells is enclosed at its outer face by a mechanical bracing device. This on the one hand brings about stationary fixing of the battery cells of the stack of battery cells relative to adjacent battery cells and also prevents an excessive increase in the volume of the battery cells when in operation as a result of the electrochemical processes inside the battery cells.

Between the outer face of the stack of battery cells and the mechanical bracing device there is a layer of a thermally conductive material. This ensures that thermal energy generated in the battery cells passes across the outer wall of the corresponding battery cell and the thermally conductive material into the material of the mechanical bracing device, which may in particular take the form of a band clamp. Since the mechanical bracing device is in correspondingly configured thermal contact also with adjacent battery cells, the thermal energy arising locally in a battery cell can be purposefully distributed to adjacent battery cells and so dissipated.

Furthermore, thermal imbalances within the stack of battery cells are successfully avoided, since any different temperature and thermal levels that may arise within the battery cells of the stack of battery cells are compensated by way of the thermally conductive material or the mechanical bracing device.

Further advantageous embodiments of the present invention are the subject matter of the subclaims.

It is advantageous, for instance, for the thermally conductive material or thermal interface material (TIM) to be a heat transfer paste or to take the form of a “gap filler” or a “gap pad”. A gap pad is understood to be a resilient, thermally conductive, flat packing piece, which, due to its material thickness and resilience, may for example also compensate differences in height between components and is suitable for connecting components from which heat is to be dissipated for example to heat sinks. Furthermore, a gap filler is understood to mean a material layer comprising a thermally conductive material which provides good mating of different surfaces, wherein the material of the gap filler may yield reversibly sideways in response to corresponding pressure. It may comprise pasty or crosslinking structures.

This enables effective thermally conductive connection of components to be cooled for example to a heat sink with compensation of any height differences between the components. Furthermore, the use of a thermally conductive adhesive as adhesive material is also feasible, this leading to mechanical fixing of the battery cells of the stack of battery cells to the mechanical bracing device, wherein the adhesive material additionally contains fillers of a pronounced thermally conductive nature.

It is furthermore advantageous for the mechanical bracing device to take the form of a metallic band clamp. This ensures not only the possibility of effective bracing of the battery cells of the stack of battery cells but also at the same time effective heat transfer from a cell of the stack of battery cells to an adjacent or further away battery cell due to the high thermal conductivity of conventional metallic materials.

According to a further advantageous embodiment of the present invention, the mechanical bracing device takes the form of two end plates, which are in each case located at one end of the stack of battery cells of the battery module and which are in each case bonded or form-lockingly connected with band clamps positioned laterally against the longitudinal sides of the stack of battery cells and in this way form a mechanical bracing device completely surrounding the stack of battery cells.

According to a particularly advantageous embodiment of the present invention, between individual ones or all of the battery cells of the stack of battery cells a thermally insulating separator is located in each case between the battery cells. This may be achieved by application of a heat-insulating material to the housing of the battery cells or by insertion of a flat, heat-insulating pad between the housing of two battery cells, for example when producing the stack of battery cells.

The advantage of this measure is that direct thermal contact between two adjacent battery cells of the stack of battery cells is successful prevented. Should a thermal event take place in one of the battery cells of the stack of battery cells, for example, which event may lead for example to destruction of the battery cell in question, the excessive quantities of heat generated during said event thus do not spread directly also to adjacent battery cells, which might then in turn undergo thermal destruction, but rather the thermal event remains spatially limited to the battery cell in question.

At the same time, however, the thermally conductively connected mechanical bracing device also permits dissipation from one battery cell to adjacent battery cells of the quantities of heat conventionally arising in the battery cells when they are in operation. In this way, thermal load peaks which conventionally arise during operation within one battery cell of the stack of battery cells may be dissipated to adjacent battery cells. This extends the operational and service life of the battery cells of the stack of battery cells.

It is advantageous for the stack of battery cells to be in thermally conductive contact at the bottom thereof, relative to the housing arrangement of the battery cells in question, with a cooling device through which a cooling medium flows, for example.

In this way, a further transfer path is present for conveying resultant or required thermal energy in and out of a battery cell in question of the stack of battery cells. At the same time, the thermally conductive connection of the battery cells to a corresponding heat sink and the simultaneous thermally conductive connection of the relevant battery cells to the mechanical bracing device serves as two mutually redundant systems for transferring thermal energy out of the battery cells or thereinto. This increases the availability of the corresponding battery module. Should the thermal contact between one of the battery cells and the mechanical bracing device or the heat sink be lost, a minimum cooling action remains available via the in each case other heat-supplying or -dissipating path.

The battery module according to the invention may advantageously be used in batteries for use in electrically or partially electrically driven road vehicles, such as battery electric vehicles, hybrid vehicles or plug-in hybrid vehicles or fuel cell vehicles, in batteries for DIY appliances or kitchen appliances and in batteries for stationary storage facilities in particular for renewably generated electrical energy.

### BRIEF DESCRIPTION OF THE DRAWINGS

The drawings show advantageous embodiments of the present invention, which are described in greater detail in the following description of the figures in which

FIG. 1 is a schematic representation of a battery module according to a first advantageous embodiment of the present invention,

FIG. 2 shows a schematic longitudinal section through a battery module according to FIG. 1,

FIG. 3 shows a schematic cross-section of battery module according to FIG. 1.

### DETAILED DESCRIPTION

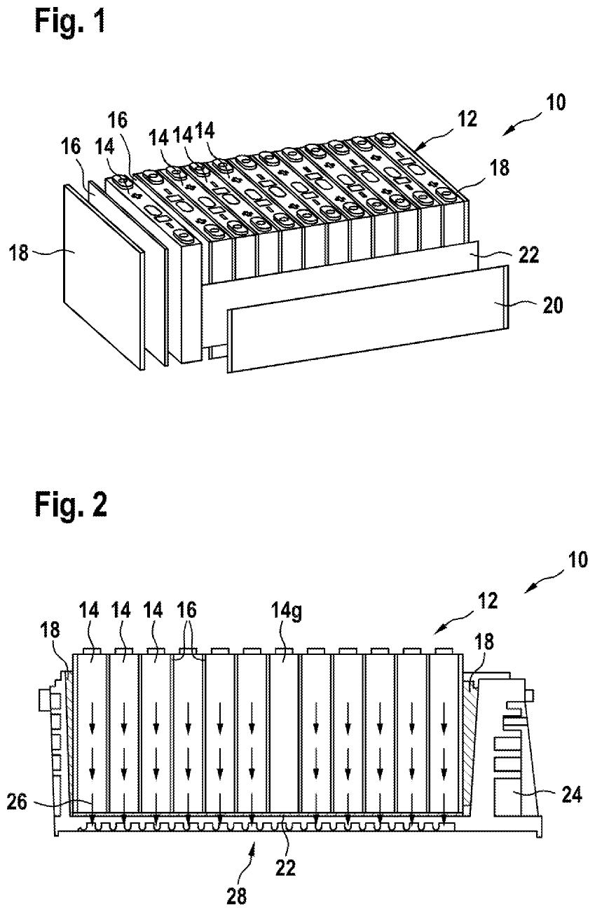

FIG. 1 shows a battery module 10 comprising a plurality of battery cells 14, which form a stack 12 of battery cells. Between the battery cells 14 are located, for example, separators or spacers 16, which insulate the battery cells 14 of the stack 12 of battery cells electrically and thermally conductively from one another. To this end, the separator 16 may for example be made of a material of low electrical conductivity and low thermal heat transfer coefficient. Plastics materials are feasible for this purpose, for example, taking the form of films, coatings or foams. Alternatively, the separator 16 may also take the form of an air gap.

Furthermore, the battery module 10 preferably comprises two end plates 18, which in each case define the ends of the stack 12 of battery cells. The end plates 18 are made from a metallic material such as in particular steel or aluminum, for example. Furthermore, the battery module 10 comprises at least one, in particular two bracing devices 20, which are for example in each case positioned on one longitudinal side of the stack 12 of battery cells 12 and connected in bonded or optionally also form-locking manner with the end plates 18.

The bracing device 20 is made from a thermally conductive material, such as for example a metallic material, for example. Steel or aluminum are examples of suitable metallic materials. The bracing device 20 may for example take the form of a band clamp and be provided for additional electrical insulation with a coating for example of a cathodic electro-dipcoat (CED), an insulation film or by anodizing the band clamp.

The band clamp is preferably welded together with the end plates 18. The particular advantage of using steel materials for the bracing unit 20 or the end plates 18 is that steel materials have a high tensile strength, high elongation at break and a high modulus of elasticity. This means that mechanical forces within the stack 12 of battery cells can be readily captured. Steel additionally has good thermal conductivity. The end plates 18 and/or the bracing device 20 may alternatively also be made from an aluminum alloy, since aluminum alloys also have an appropriate tensile strength, elongation at break or an appropriate modulus of elasticity. Like steel, aluminum also has very good thermal conductivity.

As shown in FIG. 1, a separator 16 is also provided between the end plate 18 and a first battery cell 14 of the stack 12 of battery cells. The effect of this is that heat transfer from the end plate 18 to the housing of the battery cell 14 in the end position is prevented and excessive input of thermal energy into the relevant battery cell 14 is thereby prevented.

Between the bracing device 20 and the lateral longitudinal side of the stack 12 of battery cells is a layer of thermally conductive material 22. Via the layer of thermally conductive material 22, heat is transferred out of the battery cells 14 via the lateral housing wall thereof and the layer of thermally conductive material 22 to the bracing device 20. Within the material of the bracing device 20 the heat is distributed to adjacent battery cells 14. In this way, local overheating of individual battery cells 14 of the stack 12 of battery cells can be effectively prevented. The thermally conductive material used as the layer of thermally conductive material 22 may for example be a thermal interface material (TIM) such as for example a heat transfer paste or a gap filler or also a corresponding heat-conducting adhesive or a gap pad.

In the course of production of the battery module 10, the material of the layer to be produced of a thermally conductive material 22 may in this case firstly be applied to the surface of the bracing device 20 and this may be positioned with the layer produced thereon of a thermally conductive material 22 on a lateral longitudinal side of the stack 12 of battery cells and bonded together with the end plates 18. This procedure advantageously allows prefabrication of the bracing device 20.

The advantage of the stated thermally conductive materials for the layer of thermally conductive material 22 consists in the fact that these materials not only provide sufficient thermal conductivity but also compensate manufacturing tolerances in respect of positioning of the battery cells 14 within the stack 12 of battery cells. Thus effective thermal connection of the battery cells 14 to the layer of thermally conductive material 22 is maintained.

For this reason, the layer of thermally conductive material 22 is provided with a layer thickness which enables such a function, depending on the necessary manufacturing accuracy. The minimum layer thickness of the layer of thermally conductive material 22 is dimensioned such that, depending on specifications, contaminant particles on the surface of the battery cells 14 are smaller than the layer thickness of the layer of thermally conductive material 22. In this way, penetration through the layer of thermally conductive material 22 by dirt particles is ruled out. In one advantageous embodiment, the layer of thermally conductive material 22 is at the same time formed of an electrically insulating material, such that the bracing device 20 is electrically separated from the cell housing of the battery cells 14.

In a particularly advantageous embodiment, the layer of thermally conductive material 22 takes the form of a layer of a thermally conductive adhesive. The particular advantage of this embodiment consists in the fact that, when a thermally conductive adhesive is used, the bracing device 20 can be bonded directly to a lateral longitudinal side of the stack 12 of battery cells and further fixing of the bracing device 20 on the longitudinal side of the stack 12 of battery cells is dispensed with.

After manufacture, the stack 12 of battery cells is inserted into a frame 24 of the battery module 10. This is apparent for example from FIG. 2, in which the same reference signs denote the same components as in FIG. 1.

As is apparent in FIG. 2, when in operation heat is transferred, as shown by arrows 26, primarily out of the battery cells 14 through the respective bottom face thereof towards a schematically illustrated cooling device 28, through which, for example, a cooling medium such as a water/glycol-based coolant flows. This thermal transfer requires the bottom faces of the battery cells 14 to be connected sufficiently thermal conductively to the heat sink 28.

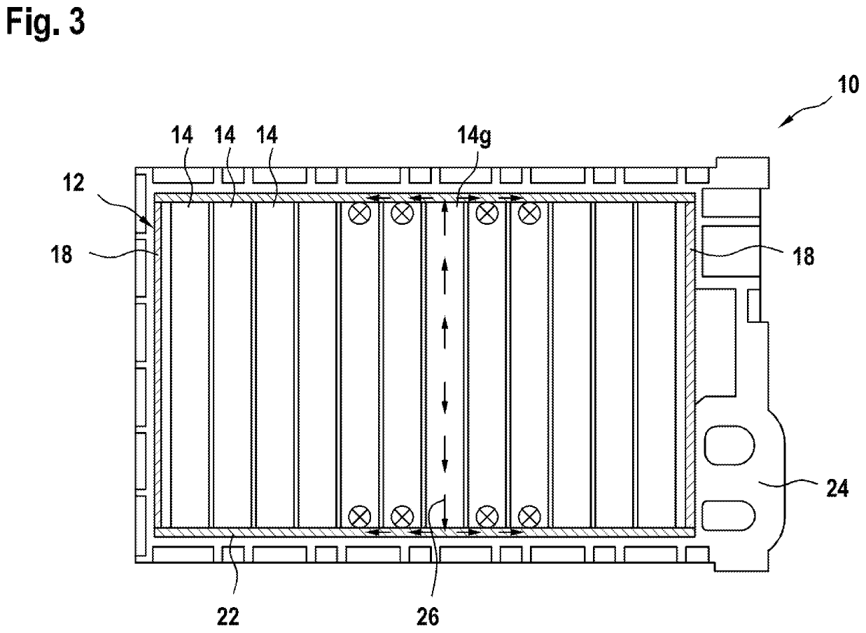

Due to the additional dissipation of heat from the battery cells 14 via the layer of thermally conductive material 22 or the bracing device 20, a minimum level of heat dissipation from an individual battery cell 14 is effectively ensured even if the corresponding battery cell 14 is no longer in thermally conductive contact with the heat sink 28. This is shown in FIG. 2 for example in respect of battery cell 14g. Here, for example, heat dissipation via the bottom face thereof or the heat sink 28 does not take place due to a defect. In this case, as illustrated in FIG. 3, heat is dissipated via the lateral faces of the battery cell 14g across the layer of thermally conductive material 22 into the bracing device 20.

The heat is transported in this case via the two side faces of the battery cell 14g and then in turn in both longitudinal directions of the stack 12 of battery cells across the bracing band 20 to adjacent battery cells 14 and absorbed therein. This ensures minimum heat dissipation of the battery cell 14g. Since, however, a separator 16 is located in each case between the battery cells 14, direct transfer of heat from one battery cell 14 to an adjacent battery cell 14 is barely possible within the battery module 10.

This prevents a thermal event within a single battery cell 14 from leading to a chain effect in the form of a spreading of the thermal event to adjacent battery cells. At the same time, however, effective heat dissipation from a battery cell affected in this way is ensured over an appropriately extended period. In this way, an adverse thermal event in an individual battery cell 14 may be locally contained, while temperature peaks within one battery cell 14 of the stack 12 of battery cells may however be effectively reduced by dissipation of heat from the battery cell 14 in question into adjacent battery cells 14 or into the material of the heat sink 28.

1. A battery module comprising a plurality of battery cells (14), the plurality of battery cells (14) being arranged in the form of a stack (12) of battery cells and the stack (12) of battery cells being enclosed at an outer face by a mechanical bracing device (20), characterized in that a layer of thermally conductive material (22) is located between the outer face of the stack (12) of battery cells and the mechanical bracing device (20).

2. The battery module according to claim 1, characterized in that the thermally conductive material (22) takes the form of heat transfer paste, gap filler, a gap pad or a layer of a thermally conductive adhesive.

3. The battery module according to claim 1, characterized in that the mechanical bracing device (20) takes the form of a metallic band clamp.

4. The battery module according to claim 1, characterized in that an end plate (18) is provided at each end of the stack (12) of battery cells, which end plate is in each case bonded or form-lockingly connected with band clamps provided laterally at longitudinal sides of the stack (12) of battery cells, so as to provide mechanical bracing of the stack (12) of battery cells.

5. The battery module according to claim 1, characterized in that a heat-insulating separator (16) is provided between battery cells (14) of the stack (12) of battery cells.

6. The battery module according to claim 1, characterized in that the stack (12) of battery cells is in thermally conductive contact at a bottom thereof, relative to the battery cells (14), with a heat sink (28) through which a cooling medium flows.

7. A method for producing a battery module according to claim 1, characterized in that the layer of a thermally conductive material (22) is applied between the outer face of the stack (12) of battery cells and the bracing device (20) encompassing the stack (12) of battery cells.

8. The method according to claim 7, characterized in that the thermally conductive material (22) is applied to one face of the mechanical bracing device (20) and in a second step the mechanical bracing device (20) provided with the thermally conductive material (22) is positioned on an outer face of the stack (12) of battery cells.

9. A use of a battery module according to claim 1 in batteries for electrically or partially electrically driven road vehicles or aircraft, in batteries for DIY appliances or kitchen appliances and in batteries in storage facilities for renewably generated electrical energy.

10. The battery module according to claim 1, wherein the plurality of battery cells (14) are rechargeable lithium ion battery cells or lithium polymer battery cells.

11. The battery module according to claim 4, wherein the end plate (18) is metallic.
